(19) United States
(12) Patent Application Publication
(10) Pub. No.: US 2004/0153796 A1
(43) Pub. Date: Aug. 5, 2004

(54) Method and apparatus for data structure analyzing

(75) Inventor: Tomi Honkanen, Lempaala (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/681,491

(22) Filed: Oct. 7, 2003

(30) Foreign Application Priority Data
Oct. 31, 2002 (FI) 20021939

(51) Int. Cl. H04L 1/22

(52) U.S. Cl. 714/27

(57) ABSTRACT

A method and a device for detecting risky types of data structures of a computer program code with a neural network. The neural network comprises neurons being related to each other by a topological arrangement involving a neighborhood definition. The neurons each comprising a vector for representing values of an input data space, at least one neuron having an associated label indicating the type of the neuron, and the data structures being detected comprising at least two elements. Information is extracted from at least two data elements from said at least one data structure and at least two input vectors are formed from said extracted information, the vectors being compatible with the vectors of the neurons. Said input vectors are compared with said vectors of the neurons, and the type of said basic data element is detected by using an associated label on the basis of said comparison.

The present invention relates to a method and apparatus for data structure analyzing and particularly, although not necessarily, for detecting risky types of data structures of a program code based on self-organizing maps.

### BACKGROUND OF THE INVENTION

Runtime errors of applications compiled to different operating system platforms are often affected because of incorrect function of memory reservation of the application. There may be restrictions in the operating system or architecture, for example, from what address may that space begin that is reserved to one parameter or variable or how large is the size of the memory unit to be reserved to the parameter or variable. Sometimes, a clear error is not created and the execution of the application continues, but the memory space of the application gets corrupted because of an incorrect data structure. There are some heuristic rules for checking data structures from computer program code, but they are usually rather laborious to perform.

In currently used processors the data residing in memory is presented as bytes (8 bit), half words (16 bit), words (32 bit) and multiple words (64 bit, 128 bit, etc.). Arrays (several objects of the same type), structures (sequence of objects of various types) and unions (allows objects of different types use the same address space) are derived from these basic types. Now, depending on processor architecture and used memory system the same data is located differently in the memory in different systems i.e. binary representation of the SW differs in different systems. Also compilers produce non-binary compatible code by aligning data items in memory at 8, 16 or 32 bit boundaries by adding additional bytes i.e. padding bytes into the allocated memory.

In the following exemplary illustration a variable type of structure is defined:

Struct s1 {
byte a1;
long int b1;
short int c1;
}

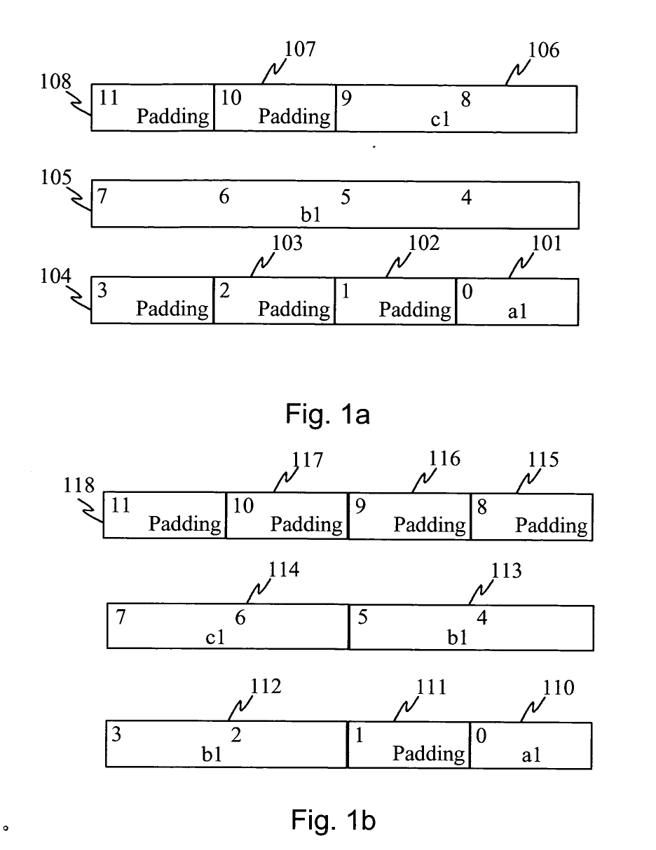

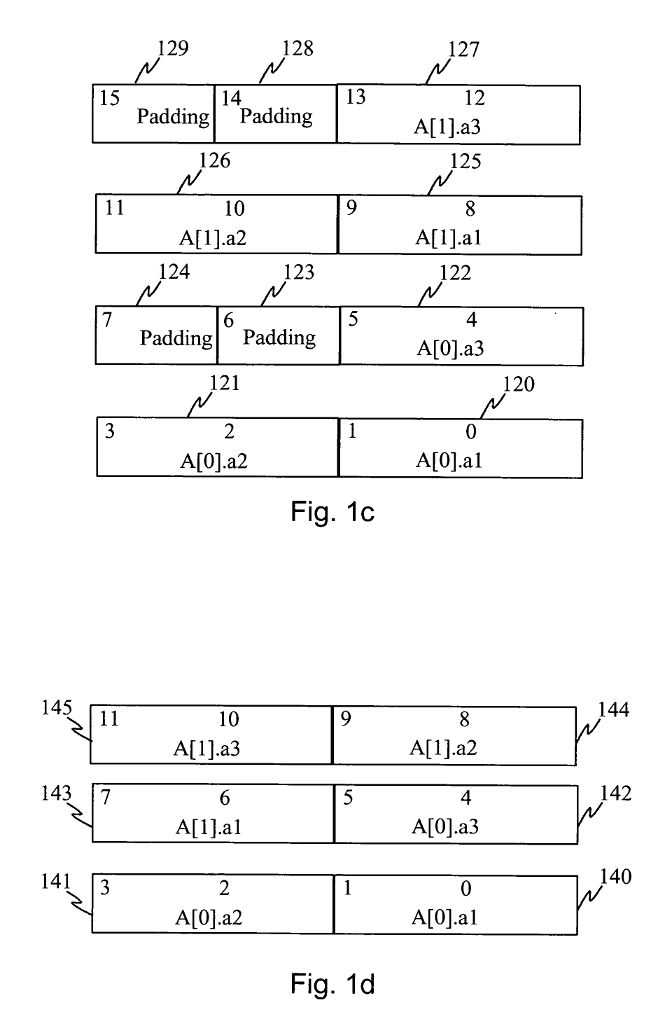

The structure s1 can be seen in memory space for example as illustrated in FIGS. 1a and 1b. FIG. 1a illustrates one possible arrangement of the memory space, wherein byte 0 (101) comprises the 8-bit data item “a1”. The bytes 1 to 3 (102-104) each comprise one padding byte. The following bytes 4-7 comprise the 32-bit data item “long int b1”. The bytes 8 and 9 (106) comprise the 16-bit data item “short int c1” and the following bytes 10 and 11 (107 and 108) each comprise one padding byte.

FIG. 1b illustrates another possible arrangement of the memory space, wherein byte 0 (110) comprises the 8-bit data item “a1” and byte 1 (111) comprises a padding byte. The bytes 2 to 5 (112 and 113) comprise the 32-bit data item “long int b1” and the bytes 6 and 7 (114) comprise the 16-bit data item “short int c1”. The bytes 8-11 (115-118) comprises padding bytes.

In another exemplary illustration an array of structures is defined as:

```
struct s2 {
    short int a1;
    short int a2;
    short int a3;
    }
```

The structure s2 can be seen in memory space for example as illustrated in FIGS. 1c and 1d. In this example for each short int “a1”, “a2” and “a3” there are three memory spaces that reserved for each of them. For short int “a2” and “a3” all of the memory spaces are not shown on the pictures 1c and 1d. The memory spaces A[0].a1, A[1].a1 and A[2].a1 are reserved for short int “a1”, A[0].a2, A[1].a2 and A[2].a2 are reserved for short int “a2” etc. FIG. 1c illustrates one possible arrangement of the memory space, wherein for example the data item “a1” is located at bytes 0, 1, 8, 9, 16 and 17 (corresponding reference numerals in FIG. 1c are 120, 125 and 130). Padding bytes are located at bytes 6, 7, 14 and 15.

FIG. 1d illustrates another possible arrangement of the memory space without the padding bytes, wherein the data items “a1”, “a2” and “a3” are located differently compared to FIG. 1c. For example, the previously mentioned “a1” is now located at bytes 0, 1, 6, 7, 12 and 13 (the corresponding reference numerals in FIG. 1d are 140, 143 and 146).

Common hazardous use of data types is caused by improper pointing and casting of the data types belonging to a data structure, which occurs especially easily in the case of arrays. The result of an operation where the items of the array of s2 are referred to via direct memory operation like incrementing an address variable so that it points to the 4th short int element of the array defined in the example varies depending on the operating system or the compiler. The content of the address could be the wanted A[1].a1 or the padding bytes 123 and 124. The similar situation occurs in the structure “s1” case, wherein the content of the bits 8 and 9 could be the wanted “c1” (106) or the padding bytes (115 and 116) varying depending on the operating system or the compiler.

It is difficult to detect problems related to memory structure mapping when reusing software from devices of different processor and memory mapping systems or when a different compiler is used.

### SUMMARY OF THE INVENTION

Now a method, and an electronic device have been invented, by which it is possible to examine the safety of memory structures of a computer program code, for example that of compiled program code or source code. The method according to the invention can be implemented for example as a computer program code stored into the memory of the electronic device. Defined data structures in the source code are classified with the aid of a neural network comprising neurons being related to each other by a topological arrangement involving a neighborhood definition. The neurons each comprises a vector for representing values of an input data space, at least one neuron having an associated label indicating the type of the neuron. The neural network can be for example the Self Organizing Map (SOM). Then, data structures that are already known to be for example defective or risky can be detected based on characteristics found by the SOM.

According to a first aspect of the invention a method is provided for detecting risky types of data structures of a computer program code with a neural network, said neural network comprising at least two neurons, and the neurons being related to each other by a topological arrangement involving a neighborhood definition, each of the neurons comprises a vector for representing elements of an input data space, at least one neuron having an associated label indicating the type of the neuron, and the data structures being detected comprising at least two elements, characterized in that the method comprises, extracting information of at least two data elements from at least one data structure, forming at least two input vectors from said extracted information of the data elements, the vectors being compatible with the vectors of the neurons, comparing said input vectors with said vectors of the neurons, and detecting the type of said at least one data structure by using an associated label obtained on the basis of said comparison.

According to a second aspect of the invention an electronic device is provided for detecting risky types of data structures of a computer program code with a neural network, said neural network comprising at least two neurons, and the neurons being related to each other by a topological arrangement involving a neighborhood definition, each of the neurons comprises a vector for representing elements of an input data space, at least one neuron having an associated label indicating the type of the neuron, and the data structures being detected comprising at least two elements, characterized in that the device comprises, extracting means for extracting information of at least two data elements from at least one data structure, formation means for forming at least two input vectors from said extracted information of the data elements, the vectors being compatible with the vectors of the neurons, comparison means for comparing said input vectors with said vectors of the neurons, and detecting means for detecting the type of said data structure by using an associated label obtained on the basis of said comparison.

According to a third aspect of the invention a computer program product is provided for an electronic device for detecting risky types of data structures of a computer program code with a neural network, said neural network comprising at least two neurons, and the neurons being related to each other by a topological arrangement involving a neighborhood definition, each of the neurons comprises a vector for representing elements of an input data space, at least one neuron having an associated label indicating the type of the neuron, and the data structures being detected comprising at least two elements, characterized in that the computer program product comprises, computer program code for causing the electronic device to extract information of at least two data elements from at least one data structure, computer program code for causing the electronic device to form at least two input vectors from said extracted information of the data elements, the vectors being compatible with the vectors of the neurons, computer program code for causing the electronic device to compare said input vectors with said vectors of the neurons, and computer program code for causing the electronic device to detect the type of said data structure by using an associated label obtained on the basis of said comparison.

When using the present invention, software testing and analysing can be focused on the risky structures and usage of those. The nature of neural network adds robustness into classification so that even previously unknown combination of the basic data elements can be mapped into the self-organizing map and classified with a certain confidence.

In the following, the invention will be described in greater detail with reference to the accompanying drawings, in which

FIGS. 1a and 1b illustrates a variable type of structure in memory space;

FIGS. 1c and 1d illustrates an array of structures in memory space;

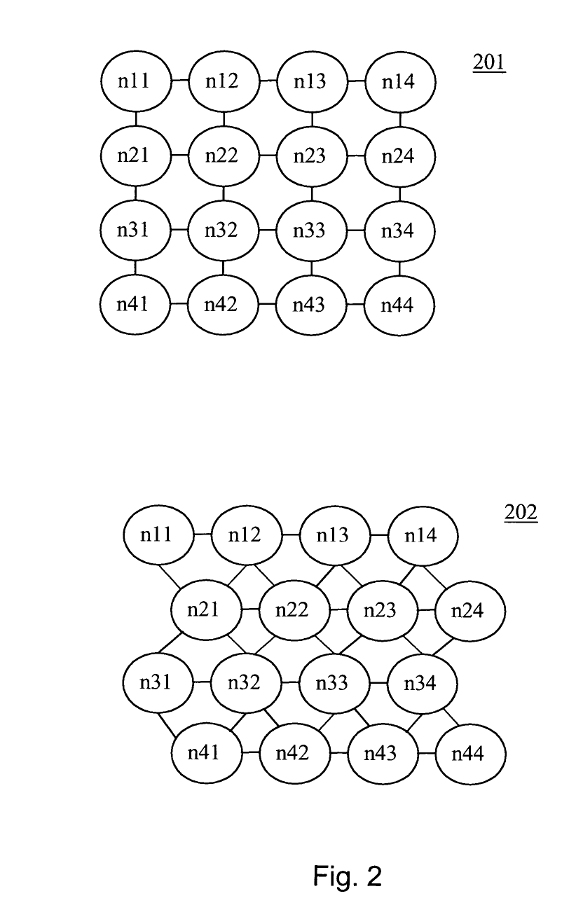

FIG. 2 illustrates a map of neurons according to an embodiment of the invention;

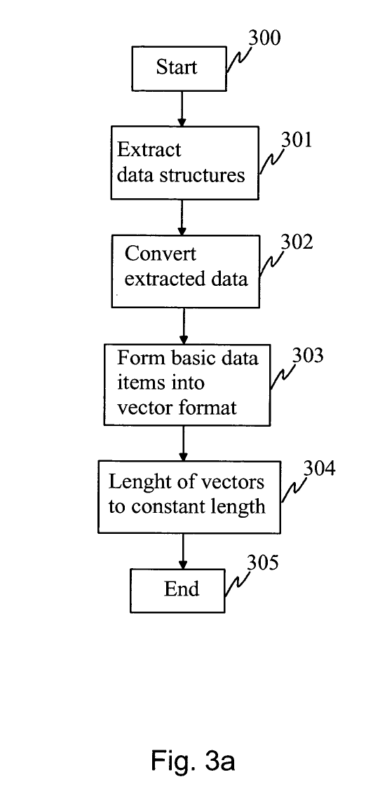

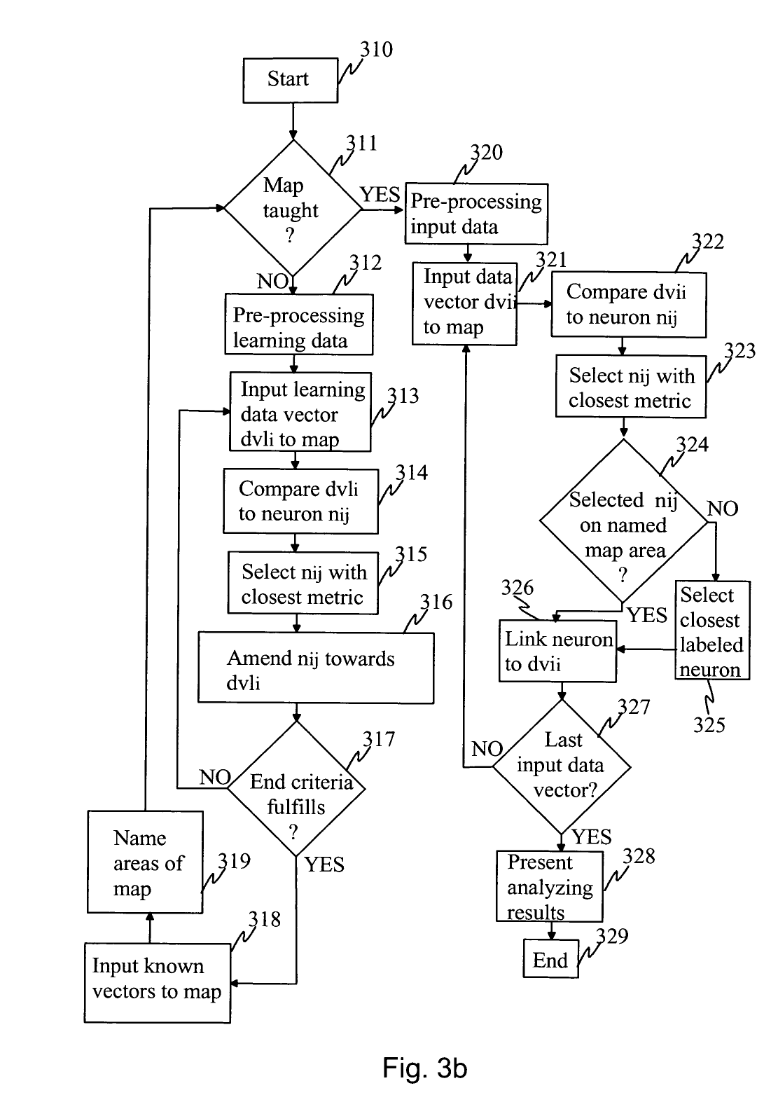

FIG. 3a illustrates a flow diagram of a method according to an embodiment of the invention;

FIG. 3b illustrates a flow diagram of another method according to an embodiment of the invention;

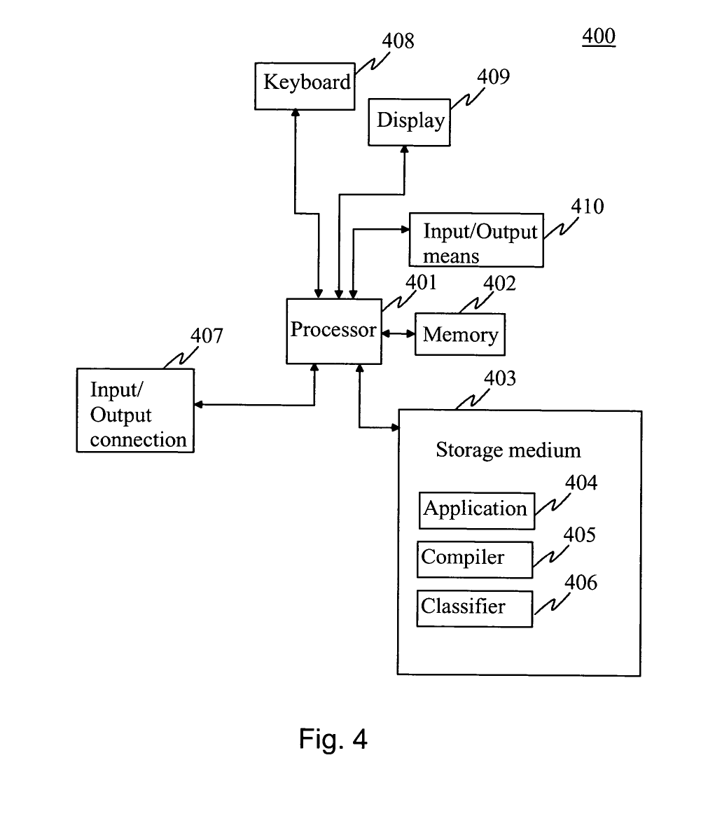

FIG. 4 illustrates a block diagram of a device according to an embodiment of the invention.

State of the art is illustrated by referring to FIGS. 1a-1d. The invention is disclosed in detail in the following by referring to FIGS. 2-4.

FIG. 2 illustrates a map of neurons according to an embodiment of the invention. A self-organizing map is a group of neurons that are organized as a grid M=[m₁, . . . mₙ]. The SOM algorithm is based on unsupervised, competitive learning. It provides a topology-preserving mapping from the high dimensional space to map units. The property of topology preserving means, that the mapping preserves the relative distance between the points. Map units, or neurons, usually form a two-dimensional lattice and thus the mapping is a mapping from high dimensional space onto a plane. However, the lattice can also be more than 2-dimensional, for example a 3-dimensional lattice organized in the shape of a toroid or a spheroid, and also a 4-dimensional lattice formed as a combination of 3-dimensional lattices, or a lattice of even higher dimensionality. Moreover, the lattice is preferably directionally shaped, that is, the dimensions of the lattice along one coordinate axis differ from the dimensions of the lattice along another coordinate axis. The edges of the lattice may be arranged to repeat the structure of the lattice, for example by connecting the adjacent edges of the lattice to each other. Points that are near each other in the input space are mapped to nearby map units in the SOM. The SOM can thus serve as a cluster-analyzing tool of high-dimensional data. Also the SOM has the capability to generalize, which means that the network can recognize or characterize inputs it has never encountered before. A new input is assimilated with the map unit it is mapped to The Self-Organizing Map may be for example a two-dimensional array of neurons. One neuron is a vector called the codebook vector mᵢ=[mᵢ₁, . . . , mᵢₙ]. This has the same dimension as the input vectors. The neurons are connected to adjacent neurons by a neighborhood relation. This dictates the topology, or the structure, of the map. Usually, the neurons are connected to each other via rectangular (201) or hexagonal topology (202) as illustrated in FIG. 2. Lines between the neurons show the topological relations.

When teaching a self-organizing map, learning vectors are inputted to the map as input data. Training is an iterative process through time. It requires a lot of computational effort and thus is time-consuming. Training consists of drawing sample vectors from the input data set and “teaching” them to the SOM. The teaching consists of choosing a winner unit neuron by the means of a similarity measure and updating the values of codebook vectors of the neurons in the neighborhood of the winner unit neuron. This process is repeated a number of times.

In one training step, one sample vector is drawn randomly from the training data set. This vector is fed to all units in the network and a similarity measure is calculated between the input data sample and all the codebook vectors. The best-matching unit (BMU) is chosen to be the codebook vector with greatest similarity with the input sample. The similarity is usually defined by means of a distance measure.

For example in the case of Euclidean distance the best-matching unit is the closest neuron to the sample in the input space. The self organizing map defines a mapping from the input data space Rⁿ onto a regular two-dimensional array of nodes. With every node i, a parametric reference vector mᵢ∈Rⁿ is associated. An input vector x∈Rⁿ is compared with the mᵢ, and the best match is defined as “response” the input is thus mapped onto this location. The input vector x can be compared with all the mi in any metric; in practical applications, the smallest of the Euclidean distances ∥x−mᵢ∥ is usually made to define the best-matching node, signified by the subscript c: ∥x−m_{c}∥=minᵢ {∥x−mᵢ∥}, or c=arg minᵢ {∥x−mᵢ∥}. Thus x is mapped onto the node c relative to the parameter values mᵢ.

Also other methods, such as the Hamming distance, can be used. The Hamming distance is defined only for strings of the same length and it is the number of places in which two strings differ, i.e., have different characters. Also, other suitable measures like the Taxicab drivers distance or L1 norm, or dot product, can be used.

The chosen codebook vector and its neighbor codebook vectors are then assimilated towards the input data sample so, that the amount of assimilation decreases when moving away from the chosen codebook vector. When the teaching process has been carried out, the self-organizing map is ordered in a way where the codebook vectors of neighbor neurons are relatively close each other and vectors of learning data are presented at the neurons of the map.

FIG. 3a illustrates a flow diagram of a method according to an embodiment of the invention. The steps of the method can be preferably implemented as a computer program code stored into the memory of an electronic device.

Pre-processing is started at step 300. Data structures are extracted from compiled program code or source code at step 301. The basic data elements will be separated, and their file name and line number will be recorded for helping post processing. Problems arise when there is possibility to create several binary representations from a single data structure and combinations of those. The problem can be delimited to combinations of basic data items in a memory since it is known that compilers might generate a different kind of binary from a single item if the item is belonging into some structure or array or being a single element. Therefore it is needed to examine these combinations also (for example array of structures)—not just going through single data items. The whole structure or array is not necessarily needed because the problem arises typically in boundaries of different basic data items. That makes it possible to limit the size of the data to handle.

At step 302 extracted data is converted to comparable format. Pre-processing goes through all the memory items in a source code, by parsing nested data items and arrays. At step 303 basic data elements and boundaries between the basic data elements are formed into vector format. Input data for self organizing map (SOM) needs to be vectors where value of the vector elements needs be scaled to be in a line of all other elements so that every element of the vector can be equally distinguishable. This is normally basic assumption in neural networks. Now, there is a need to get basic data elements and boundaries between the basic data elements into vector format. Suitable solution is to scale every element into a vector, wherein each value of the vector is between 0 and 1, meaning that maximum values are known beforehand when the vectors are made. In this case we can set: 0=basic data element boundary or don't care data, 0,25=8 bit data, 0,5=16 bit data, 0,75=32 bit data and 1=data structure boundary. For example the structure s1 as illustrated in FIG. 1a can be represent in vector format as [0.25, 0, 0.75, 0, 0.5, 1], wherein 0.25 is referring to reference 101 of FIG. 1a (basic data element “a1”), next 0 is referring to the padding bytes (102-104) and to a basic data element boundary between “a1” and next basic data element “b1”, next 0,75 is referring to said “b1” (105), next 0 is referring to a basic data element boundary between said “b1” and “c1” (106), next 0,5 is referring to said “c1” (106) and last number 1 in the brackets is referring to data structure boundary. Likewise the two element long array of s2 as illustrated in FIG. 1c would be in vector format: [0.5, 0, 0.5, 0, 0.5, 1, 0.5, 0, 0.5, 0, 0.5, 1].

At step 304 vectors are made to constant length. Length of the vector depends normally on memory system and compiler characteristics, where for example 32 bit memory width can include maximum 4 elements (four bytes). The length of a memory defines the amount of data the system is capable to handle at the same time. Also it defines operation of the instruction set of the processor and the binary representation of a compiler. In order to delimit the length of the vector to be classified, we can assume that the physical length of the memory bus is enough to delimit the amount of elements to be examined. This assumption is enough because the differences in binary representations of a compiler and a linker come out with this accuracy. The exemplary 32 bit memory length delimits the length of a vector to 4 bytes and to the boundary information relating to the bytes. According these assumptions the used vector length is (in this example) 8 elements.

Long vectors are stripped into constant length by using for example sliding window method. In the sliding window method a window, having the same length as the vector to be classified, is slided over the vector so, that all of the basic data elements of the data structure are at least in one input vector. In sliding the scale spacing is something between 2 and the maximum vector length. Shorter vectors than vector length will be filled with don't care values (0) in order to achieve the constant length. At step 305 preprocessing is ended.

FIG. 3b illustrates a flow diagram of another method according to an embodiment of the invention. The steps of the method can be preferably implemented as a computer program code stored into the memory of an electronic device. The map disclosed below is a neural network, that comprises neurons being related to each other by a topological arrangement involving a neighborhood definition. Each of the neurons comprises a vector for representing values of an input data space.

The process starts at step 310. At step 311 it is checked whether the map is already taught or not. If the map is not taught the flow proceeds to step 312 where learning data is preprocessed with a method disclosed previously. Learning data vector dvlᵢ is inputted to the map at step 313. At step 314 the data vector dvlᵢ is compared to all the neurons nᵢⱼ of the map. At step 315 the neuron nᵢⱼ is selected that has the closest metric or which is the most similar with the learning data vector. Previously mentioned suitable methods like for example the Hamming distance method or the Euclidean distance method can be used. At step 316 the selected neuron nᵢⱼ and its neighbor neurons are amended towards the learning data vector. Created data vectors are processed with common self-organizing algorithm until the end criterion has fulfilled (for example iteration error stabilizes).

Result is a net of elements where each one presents a typical vector in source set and adjacent elements are logically close each others and values of individual units of vector have values something between for example [0 . . . 1]. Depending on the size of the map (predefined value for example two dimensional 8×8 net) there can be map elements very close to individual source data and different vectors create own sections to the map. With this kind of source data the result will be clearly discrete with a small amount of source data.

At step 317 it is checked whether end criteria has been fulfilled. If the end criterion has not been fulfilled, the flow proceeds to step 313 where next learning data vector is inputted to the map. If the end criterion has been fulfilled at step 317, the map is now organized and the flow proceeds to step 318, where vectors of known data structures are inputted to the map. At step 319 the organized map is analysed by mapping previously known safe and fail case vectors to the SOM and labeling areas (minimum one neuron) of the map according the analysing result e.g. “safe”, “risky”, “fail”, etc. depending of the mapping vector. The label “safe” means that the vector represents a data structure, which does not cause any problems. The label “risky” means that the vector represents a data structure, which causes problems. The label “fail” can mean for example that the vector represents a data structure, which is not known to be either risky or safe type. The size of the area to be labeled can be for example one neuron or a neuron and it's neighbour neurons, for example. The area can also have different size or form than those mentioned as an example. Labeled areas represents now classified set of used basic data item combinations to be used even separately. From step 319 the flow proceeds to step 311.

If the map is already taught at step 311, the flow proceeds to step 320 where input data is preprocessed with a method disclosed in FIG. 2a previously. Program code to be analysed with the SOM is pre-processed to vectors like the original data and mapped into analysed SOM. Input data vector dviᵢ is inputted to the map at step 321. At step 322 input data vector dviᵢ is compared to all the neurons nᵢⱼ of the map. At step 323 the neuron nᵢⱼ is selected that has the closest metric or which is the most similar with the input data vector. Previously mentioned suitable methods like for example the Hamming distance method or the Euclidean distance method can be used. Next it is checked, if the selected neuron nᵢⱼ is belonging to the labeled map area (step 324). If the neuron is not belonging to the labeled map area, the closest labeled neuron to the selected neuron of the neural network is selected and linked to the input data vector dviᵢ at step 325 and the flow proceeds to step 327. If the neuron is belonging to the labeled map area, the flow proceeds to step 326, where said neuron is linked to said input data vector dviᵢ and the flow proceeds to step 327. At step 327 it is checked if said input data vector is the last input data vector. If it is not the last one, the flow proceeds to step 321 and next input data vector is inputted to the map. If said input data vector is the last one, the flow proceeds to step 328, wherein analyzing results are formed and stored e.g. into a text file that comprises the classification of the input vector. The results may be presented for example in a 2-dimensional visual map on the screen of the computer. Finally the flow proceeds to step 329 and the process ends.

FIG. 4 illustrates a block diagram of a device according to an embodiment of the invention. The device 400 comprises a processor 401 and a memory 402 for processing the tasks to be performed in the device. The memory 402 can comprise for example random access memory (RAM) and read only memory (ROM). The device further comprises a storage medium 403, for example like a hard disk of a desktop computer, which further comprises an application 404 that may be for example an operating system of the device 400. The storage medium may further comprise other applications like a compiler application 405 for compiling computer program code in the device and a classifier application 406 according to an embodiment of the invention for classifying data structures of a computer program code. The device 400 further may comprise an input/output connection 407 for example for external devices and/or for in order to connect to the communication network or to another electronic device. The device 400 further comprises a keyboard 408, a display 409 and may further comprise an input/output means, such as a touch sensitive display for inputting and displaying information.

The device 400 is preferably a PC or other kind of computer that may be a desktop computer or a portable laptop computer. The device 400 performs the classifier application 406 illustrated in the method of FIGS. 3a and 3b when a computer program code, a code written, for example, in the C, C++, Java or J++language or other language supporting structured data types, is inputted to the application 406. The device can perform said classifier application also for compiled computer program code, which is compiled by the compiler application 405.

Implementation of the present invention is not restricted to the embodiments illustrated above. Implementation can be done with any commercial neural network toolbox, e.g. Matlab NN toolbox®. Input data is extracted and pre-filtered data structures from source code to be examined. Output is a map or a text file of structure types. Then based on existing knowledge it is possible to isolate areas from the map that presents neutral and possible risky types of data.

The above disclosure illustrates the implementation of the invention and its embodiments by means of examples. A person skilled in the art will find it apparent that the invention is not restricted to the details of the above-described embodiments and that there are also other ways of implementing the invention without deviating from the characteristics of the invention. The above embodiments should thus be considered as illustrative and not restrictive. Hence the possibilities of implementing and using the invention are only restricted by the accompanying claims and therefore the different alternative implementations of the invention, including equivalent implementations, defined in the claims also belong to the scope of the invention.

1. A method for detecting risky types of data structures of a computer program code with a neural network, said neural network comprising at least two neurons, and the neurons being related to each other by a topological arrangement involving a neighborhood definition, each of the neurons comprises a vector for representing elements of an input data space, at least one neuron having an associated label indicating the type of the neuron, and the data structures being detected comprising at least two data elements, characterized in that the method comprises,
extracting information of at least two data elements from at least one data structure,
forming at least two input vectors from said extracted information of the data elements, the vectors being compatible with the vectors of the neurons,
comparing said input vectors with said vectors of the neurons, and
detecting the type of said at least one data structure by using an associated label obtained on the basis of said comparison.

2. A method according to claim 1, characterized in that in the method said data vectors of the neurons have been formed by applying a self-organizing learning process, wherein learning data vectors have been allowed to change the vectors of the neurons by using a neighborhood mapping.

3. A method according to claim 1, characterized in that said neurons have been labeled on the basis of a labeling data item, wherein said labeling data item is examined to be at least one of the following; safe type data item, risky type data item or fail type data item.

4. A method according to claim 1, characterized in that in the method the input vector is compared to the vector of the neuron by using at least one of the following methods: the Euclidean distance, the Hamming distance, the Taxicab drivers distance, L1 norm, or dot product.

5. A method according to claim 4, characterized in that in the method the type of the data structure is detected by selecting the label of a neuron whose vector has the closest metric.

6. A method according to claim 4, characterized in that in the method the type of the data structure is detected by selecting the label of the closest neighbor of the neuron whose vector has the closest metric.

7. A method according to claim 4, characterized in that in the method the type of the data structure is detected by selecting the label of the closest labeled neuron on the map next to the neuron whose vector has the closest metric.

8. An electronic device (400) for detecting risky types of data structures of a computer program code with a neural network, said neural network comprising at least two neurons, and the neurons being related to each other by a topological arrangement involving a neighborhood definition, each of the neurons each comprises a vector for representing elements of an input data space, at least one neuron having an associated label indicating the type of the neuron, and the data structures being detected comprising at least two data elements, characterized in that the device comprises,
extracting means (401, 402, 406) for extracting information of at least two data elements from at least one data structure,
formation means (401, 402, 406) for forming at least two input vectors from said extracted information of the data elements, the vectors being compatible with the vectors of the neurons,
comparison means (401, 402, 406) for comparing said input vectors with said vectors of the neurons, and
detecting means (401, 402, 406) for detecting the type of said data structure by using an associated label obtained on the basis of said comparison.

9. A device according to claim 8, characterized in that the device further comprising second forming means (401, 402, 406) for forming said data vectors of the neurons by applying a self-organizing learning process, wherein learning data vectors have been allowed to change the vectors of the neurons by using a neighborhood mapping.

10. A device according to claim 9, characterized in that the second forming means (401, 402, 406) are further arranged to label the neurons on the basis of a labeling data item, wherein said labeling data item is examined to be at least one of the following; safe type data item, risky type data item or fail type data item.

11. A device according to claim 8, characterized in that in the comparison means (401, 402, 406) are arranged to compare the input vector to the vector of the neuron by using at least one of the following methods: the Euclidean distance the Hamming distance, the Taxicab drivers distance, L1 norm, or dot product.

12. A device according to claim 8 or 11, characterized in that the detecting means (401, 402, 406) are arranged to detect the type of the data structure by selecting the label of a neuron whose vector has the closest metric.

13. A device according to claim 8 or 11, characterized in that the detecting means (401, 402, 406) are arranged to detect the type of the data structure by selecting the label of the closest neighbor of the neuron whose vector has the closest metric.

14. A device according to claim 8 or 11, characterized in that the detecting means (401, 402, 406) are arranged to detect the type of the data structure by selecting the label of the closest labeled neuron on the map next to the neuron whose vector has the closest metric.

15. A computer program product for an electronic device for detecting risky types of data structures of a computer program code with a neural network, said neural network comprising at least two neurons, and the neurons being related to each other by a topological arrangement involving a neighborhood definition, each of the neurons comprises a vector for representing elements of an input data space, at least one neuron having an associated label indicating the type of the neuron, and the data structures being detected comprising at least two data elements, characterized in that the computer program product comprises,
computer program code for causing the electronic device to extract information of at least two data elements from at least one data structure,
computer program code for causing the electronic device to form at least two input vectors from said extracted information of the data elements, the vectors being compatible with the vectors of the neurons,
computer program code for causing the electronic device to compare said input vectors with said vectors of the neurons, and
computer program code for causing the electronic device to detect the type of said data structure by using an associated label obtained on the basis of said comparison.
